(19) United States
(12) Patent Application Publication
(10) Pub. No.: US 2012/0318743 A1
(43) Pub. Date: Dec. 20, 2012

(54) Water Desalination and Treatment System and Method

(76) Inventor: Ockert Tobias Van Niekerk, Polokwane (ZA)

(21) Appl. No.: 13/580,596

(22) PCT Filed: Feb. 23, 2011
(86) PCT No.: PCT/IB2011/050740

§ 371 Date: Aug. 23, 2012

(30) Foreign Application Priority Data
Feb. 24, 2010 (ZA) 2009/08330
Sep. 15, 2010 (ZA) 2010/06606

(51) Int. Cl. C02F 1/42; C02F 1/66; C02F 1/58

(52) U.S. Cl. 210/664; 210/673; 210/670; 210/667; 210/665; 210/252; 210/201

(57) ABSTRACT

The invention comprises water desalination methods and a system for such, which includes treatment of water in cation and anion ion exchange columns, and regenerating the columns after treatment of the water to set them up again for a further treatment cycle, and also providing recoverable by-products during the regeneration of the ion exchange columns instead of waste.

### FIELD OF THE INVENTION

This invention relates to a water desalination system and method thereof and in particular a process for providing water with a lowered salinity and which produces a useful and recoverable by-product.

### BACKGROUND TO THE INVENTION

Water purification is the process of removing undesirable chemicals, materials, and biological contaminants from water from a particular source. The goal is to produce water fit for a specific purpose. Often, the salinity of the water needs to be lowered. Desalination refers to any of several processes that remove excess salt and other minerals from water. More generally, desalination may also refer to the removal of salts and minerals. This can be done by, inter alia, ion exchange.

The technology of water desalination is however fairly expensive. The process also produces waste streams which consist of the impurities present in the source water as well as chemicals used in the desalination process.

The waste stream must be removed to a dumping site and dumped in terms of environmental legislation. This adds to the costs and may have a negative environmental impact.

### OBJECT OF THE INVENTION

It is an object of the invention to provide a water desalination method and system which at least partly overcomes the abovementioned problems.

### SUMMARY OF THE INVENTION

In accordance with this invention there is provided a method of water desalination which includes the steps of:
a) passing water through a cation column which includes a resin loaded with hydrogen ions to absorb on the resin one or more of the group of cations including calcium, magnesium and sodium ions from the water and to displace the hydrogen ions;
b) passing the water from step a) through an anion column which includes a resin loaded with hydroxide ions to absorb on the resin one or more of the group of anions including sulphate and chloride ions from the water and to displace the hydroxide ions to yield desalinated water;
c) regenerating the anion column by passing a solution containing at least one species which includes hydroxide ions bound with a carrier ion, to displace from the resin the sulphate and chloride ions to leave a hydroxide loaded resin and producing mainly a solution containing a mixture of sulphate and chloride ions and the carrier ion; and
d) regenerating the cation column by:
   a. passing through the cation column a chloride containing feed solution which includes chloride ions bound with a counter-ion which has greater selective adsorption on the resin than the sodium ions, to displace from the resin almost all of the sodium ions and at least some of the other cations absorbed in step a) to leave a resin loaded with the counter-ions and some of the other cations absorbed in step a), and producing a chloride product solution containing most of the sodium and at least some of the other cations absorbed in step a) from the cation column; and
   b. passing through the cation column a nitric acid solution or a hydrochloric acid solution through the cation column to displace the cations left an the resin after step di) by hydrogen ions and to produce nitrates or chlorides of the cations left on the resin after step di) from the cation column, thereby leaving a hydrogen ion loaded cation column.

There is further provided for the hydroxide species of step c) to comprise ammonium hydroxide and for step c) to comprise passing an ammonium hydroxide solution through the anion column to displace the chloride and sulphate ions adsorbed on the resin by hydroxide ions and to produce mainly a mixture of ammonium chloride and ammonium sulphate from the anion column.

There is further provided for treating the ammonium chloride and ammonium sulphate of step c) with calcium hydroxide to produce a solution containing calcium sulphate, ammonia gas and calcium chloride, of which the calcium sulphate precipitates from the solution, the ammonia gas may be stripped from the solution and redissolved in water to form ammonium hydroxide for use in step c).

There is still further provided for the chloride containing feed solution of step di) to comprise calcium chloride and for feeding the calcium chloride solution from the step above to step di), to displace most of the sodium and some of the other cations adsorbed on the resin with calcium and to produce a chloride product solution containing most of the sodium from the cation column, and for the nitrate mixture or chloride mixture from step dii) to then comprise calcium nitrate and calcium chloride respectively.

There is further provided, should the nitrate mixture from the cation column from step dii) contain any magnesium for calcium hydroxide to be added to the mixture, allowing the magnesium nitrate to react with the calcium hydroxide to form calcium nitrate in solution and magnesium hydroxide precipitate which is separable from the solution; and further optionally neutralizing the magnesium hydroxide with nitric acid to form magnesium nitrate and water; alternatively neutralizing the magnesium hydroxide with sulphuric acid to form magnesium sulphate and water.

There is still further provided, should the chloride mixture from the cation column from step dii) contain any magnesium for calcium hydroxide to be added to the mixture from the cation column from step dii), allowing the magnesium chloride to react with the calcium hydroxide to form calcium chloride in the solution and magnesium hydroxide precipitate which is separable from the solution; and further optionally contacting the calcium chloride with sulphuric acid to form calcium sulphate precipitate and hydrochloric acid, of which the latter is preferably passed through the cation column in step dii) again.

According to a further feature of the invention there is provided for the chloride containing feed solution of step di) to comprise potassium chloride and for step di) to comprise passing potassium chloride solution through the cation column to displace mainly sodium adsorbed on the resin with potassium, to produce mainly sodium chloride from the cation column, and for step dii) to comprise passing nitric acid through the cation column to displace calcium, magnesium and potassium adsorbed on the resin by hydrogen ions and to produce calcium nitrate, magnesium nitrate and potassium nitrate from the cation column, thereby leaving a hydrogen ion loaded cation column.

There is also provided for passing the potassium chloride solution through the cation column in step di) in a volume sufficient to displace all the cations on the cation column to produce sodium chloride, magnesium chloride and calcium chloride; and passing nitric acid through the cation column to produce potassium nitrate from the cation column, thereby leaving a hydrogen ion loaded cation column.

According to an alternative feature of the invention there is provided for step c) to comprise passing a sulphuric acid solution, which has a greater selective adsorption on the resin, through the anion column to displace the chloride ions adsorbed on the resin by sulphate ions and to produce mainly hydrochloric acid from the anion column, and thereafter passing an ammonium hydroxide solution through the anion column to displace sulphate ions adsorbed on the resin with hydroxide ions and producing an ammonium sulphate solution from the anion column, thereby leaving a hydroxide ion loaded anion column, and optionally neutralizing the hydrochloric acid by means of calcium carbonate to produce a solution containing carbonic acid and calcium chloride, of which the carbonic acid dissociates mostly into water and carbon dioxide in solution, alternatively for this hydrochloric acid to be neutralized by calcium hydroxide instead of or in addition to calcium carbonate.

There is further provided for the calcium chloride formed above to be used in step di) as the chloride feed solution.

There is further provided for the ammonium sulphate solution from above to be contacted with calcium hydroxide to form calcium sulphate that precipitate from the solution and optionally for the ammonium hydroxide that can be re-used to displace the sulphate ions on the anion column.

In accordance with a still further aspect of this invention there is provided a method of treatment of water which includes the steps of:
a) passing water with a pH value higher than 7, as a first step, through a cation column which includes a resin loaded with hydrogen ions to absorb in the resin one or more of the group of cations including calcium, magnesium, and sodium from the water and to displace the hydrogen ions to yield water with a pH value lower than 7;
b) passing potassium chloride solution in a sufficient volume through the cation column to displace all the cations on the cation column adsorbed on the resin with potassium, to produce sodium chloride, magnesium chloride and calcium chloride from the cation column; and
c) passing nitric acid through the cation column to displace potassium adsorbed on the resin by hydrogen ions and to produce potassium nitrate from the cation column, thereby leaving a hydrogen ion loaded cation column.

According to a still further feature of the invention there is provided a method of treatment of water to reduce the pH value of the water, which includes the steps of:
a) passing water, preferably with a pH value above 7, through a cation column which includes a resin loaded with hydrogen ions to absorb in the resin one or more of the group of cations including calcium, magnesium, and sodium from the water and to displace the hydrogen ions, yielding water with a pH value lower than 7;
b) passing a potassium chloride solution through the cation column to displace mainly the sodium adsorbed on the resin by potassium ions and to produce mainly sodium chloride, thereby leaving a calcium, magnesium and potassium ion loaded cation column; and
c) passing a nitric acid solution through the cation column to displace calcium, magnesium and potassium with hydrogen and produce calcium, magnesium and potassium nitrate, thereby leaving a hydrogen ion loaded cation column.

There is further provided for the partial or full neutralisation of the water with a pH value lower than 7 by contacting it with calcium carbonate or ammonia and to yield water with an increased calcium or ammonium concentration.

According to another aspect of the invention there is provided a method of treatment of water to increase the pH value of the water, which includes the steps of:
a) passing water, preferably with a pH value below 7, through an anion column which includes a resin loaded with hydroxide ions to absorb in the resin one or more of the group of anions including sulphate and chloride ions from the water and to displace the hydroxide ions;
b) passing a sulphuric acid solution, which has a greater selective adsorption on the resin, through the anion column to displace the chloride ions adsorbed on the resin by sulphate ions and to produce mainly hydrochloric acid from the anion column; and
c) passing an ammonium hydroxide solution through the anion column to displace sulphate ions adsorbed on the resin with hydroxide ions and producing an ammonium sulphate solution from the anion column, thereby leaving a hydroxide ion loaded anion column, to yield water with a higher pH value compared to what it entered the process without increasing the total dissolved solids in the water.

There is further provided for the ammonium sulphate solution from above to be contacted with calcium hydroxide to form calcium sulphate that precipitate from the solution and optionally for the ammonium hydroxide to be re-used to displace the sulphate ions on the anion column.

According to a still further feature of the invention there is provided for the method to include the steps of removing any one or more of the group of compounds including ammonium (NH₄⁺), nitrate (NO₃⁻) and phosphate (PO₄³⁻) from source water by absorbing ammonium on the cation exchange resin and absorbing nitrate and phosphate on the anion exchange resin.

There is further provided for the regeneration of the cation column to yield a solution which includes calcium nitrate (Ca(NO₃)₂) and ammonium nitrate (NH₄NO₃), and for the regeneration of the anion column to yield a solution which includes ammonium sulphate ((NH₄)₂SO₄), ammonium phosphate ((NH₄)₃PO₄) and ammonium nitrate (NH₄NO₃).

There is also provided for ammonium sulphate solution produced from the anion column to be utilized as fertilizer, alternatively to be treated with calcium hydroxide to produce calcium sulphate precipitate and an ammonium hydroxide solution, and optionally for the ammonium hydroxide to be fed to the anion column again to displace sulphate ions adsorbed on the resin with hydroxide ions and to produce an ammonium sulphate solution from the anion column.

In accordance with a another aspect of the invention there is provided a system for the treatment of water which includes a cation exchange column including a cation exchange resin and an anion exchange column including a resin with an anion exchange resin, each column including an inlet and outlet and being in fluid communication with each other to perform the steps of the abovementioned method of water purification.

Yet a further aspect of the invention provides for an additional column containing a cation exchange resin with a selectivity for heavy metals to remove unwanted elements like heavy metals, including without limitation lead (Pb) and cadmium (Cd) to be removed from the source water prior to it entering the cation column, and for the method to include an additional step to pass source water through such a column prior to it entering the cation column.

These and other features of the invention are described in more detail below.

### BRIEF DESCRIPTION OF THE DRAWINGS

Preferred embodiments of the invention are described by way of example only and with reference to the accompanying drawings in which:

FIG. 1 is a diagrammatic representation of the method of treating water according to the invention, showing the passage of water through cation and anion columns;

FIG. 2 is a diagrammatic representation of ion exchange with a solution, where a cation exchanger containing counter ions A is placed in a solution containing counter ions B (the initial state), resulting in the redistribution of the counter ions by diffusion until equilibrium is attained (the equilibrium state);

FIG. 3 shows a concentration profile in a series of ion exchange batch tanks;

FIG. 4 is a diagrammatic representation of the displacement of hydrogen ions, as shown in FIG. 1, by calcium, magnesium and sodium ions and an indication of the distribution of the ions in the cation column, and the displacement of hydroxide ions, as shown in FIG. 1, by sulphate and chloride ions and an indication of the distribution of the ions in the anion column;

FIG. 5 is a diagrammatic representation of a method of treatment of water according to a first embodiment of the invention, showing the regeneration of the anion column with ammonium hydroxide and the cation column with calcium chloride and nitric acid;

FIG. 6 is a diagrammatic representation of the flow of liquids according to the process as shown in FIG. 5;

FIG. 7 is a diagrammatic representation of a method of treatment of water according to a second embodiment of the invention, showing the regeneration of the anion column with ammonium hydroxide and the cation column with calcium chloride and hydrochloric acid;

FIG. 8 is a diagrammatic representation of the flow of liquids according to the process as shown in FIG. 7;

FIG. 9 shows an alternative to the regeneration of the anion column by making use of sulphuric acid;

FIG. 10 is a diagrammatic representation of the flow of liquids according to the process as shown in FIG. 9;

FIG. 11 is a diagrammatic representation of a third embodiment of a method of treatment of water according to the invention, in which the cation column is regenerated by means of hydrochloric acid;

FIG. 12 is a diagrammatic representation of a fourth embodiment of a method of treatment of water according to the invention, in which the cation column is regenerated by means of potassium chloride;

FIG. 13 is a diagrammatic representation of the method shown in FIG. 12 wherein the potassium chloride solution is of an increased volume sufficient to displace all the cations on the cation column;

FIG. 14 is a diagrammatic representation of the method of the invention by using the cation column only to decrease the pH value of water; and

FIG. 15 is a diagrammatic representation of the method of the invention by using the anion column only to increase the pH value of water.

### DETAILED DESCRIPTION OF THE INVENTION

In this invention, a water desalination process provides for two columns through which source water may be passed. Source water referred to in this specification relates to the water which the user wishes to purify and may include, inter alia, sodium, calcium, magnesium, sulphates and chlorides, and also heavy metals such as lead and cadmium. The processes will be preferably performed in fixed bed columns which allows for significant volumes of water, typically about 8000 litres and more to be passed through the columns per hour.

The first column contains a cation exchange resin (R). This will hereinafter be referred to as the cation column. The second column contains an anion exchange resin (R′). This will hereinafter be referred to as the anion column.

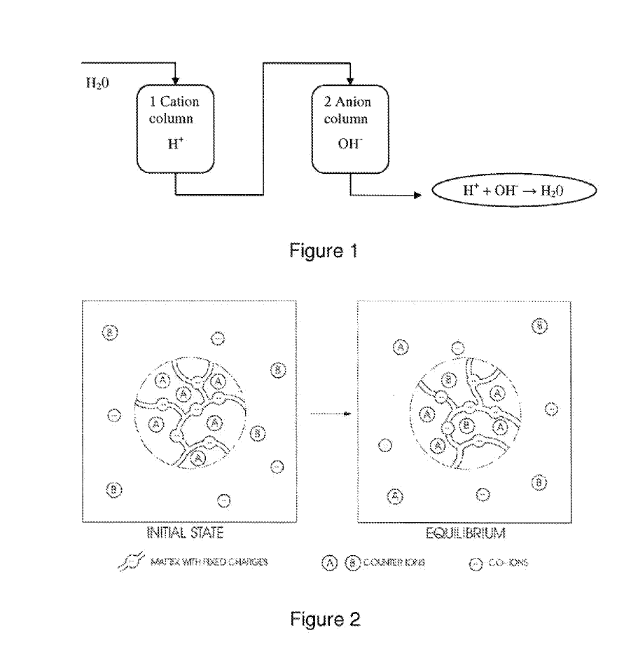

A water supply line supplies source water to the cation column and from there to the anion column. The cation column includes a resin which is initially loaded with hydrogen (H⁺) ions. The anion column includes a resin which is initially loaded with hydroxide ions (OH⁻). This is shown in FIG. 1.

In respect of resins, the ions in the solution that are in contact with the resin have different terms depending on the role they play in the process. Referring to FIG. 2, it should be noted that the resin is an insoluble substance that consists of a matrix with fixed charges. A cation resin has negative charges and the anion resin has positive charges.

Specifically in respect of a cation exchange resin, each negative charge on the resin has a positive ion or a cation associated with it called a Counter ion. When the resin is in contact with a salt solution the other negative ions in the solution is called Co-ions.

The resin's selectivity for the hydrogen ions is, apart from lithium, the lowest and to get the resin in the hydrogen or proton form it is necessary to use an excess of acid.

When an ion exchanger in the A form, where A is an arbitrary counter ion, is placed in a solution of an electrolyte BY, counter ions A will migrate from the exchanger into the solution and counter ions B from the solution into the ion exchanger, i.e. an exchange of counter ions take place. After a certain time, ion-exchange equilibrium is attained. Now, both the ion exchanger and the solution contain both counter-ion species A and B.

The concentration ratio of the two counter ions, however, is not necessarily the same.

The ratio will depend on the selectivity of the resin for a specific counter ion. If the selectivity of the resin is higher for Counter Ion B than for A, the concentration of B will be higher than A on the resin, and the concentration for A will higher than B in the solution.

In respect of the using exchange processing resins to process fluids it is important to note that ion exchange processing can be accomplished by either a batch method or a column method. In the batch method, the resin and solution are mixed in a batch tank, the exchange is allowed to come to equilibrium, then the resin is separated from solution. The degree to which the exchange takes place is limited by the preference the resin exhibits for the ion in solution. Consequently, the use of the resins exchange capacity will be limited unless the selectivity for the ion in solution is far greater than for the exchangeable ion attached to the resin. Because batch regeneration of the resin is chemically inefficient, batch processing by ion exchange has limited potential for application.

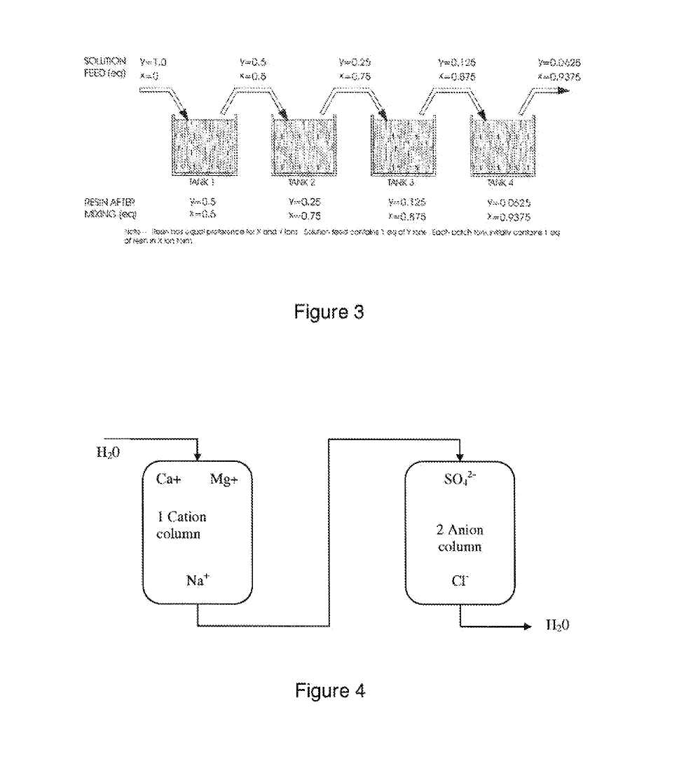

In the column method passing a solution through a column containing a bed of exchange resin is analogous to treating the solution in an infinite series of batch tanks. Consider a series of tanks each containing 1 equivalent (eq) of resin in the X ion form (see FIG. 3). A volume of solution containing 1 eq of Y ions is charged into the first tank. Assuming the resin to have an equal preference for ions X and Y, when equilibrium is reached the solution phase will contain 0.5 eq of X and Y. Similarly, the resin phase will contain 0.5 eq of X and Y. This separation is the equivalent of that achieved in a batch process.

If the solution were removed from Tank 1 and added to Tank 2, which also contained 1 eq of resin in the X ion form, the solution and resin phase would both contain 0.25 eq of Y ion and 0.75 eq of X ion. Repeating the procedure in a third and fourth tank would reduce the solution content of Y ions to 0.125 and 0.0625 eq respectively. Despite an unfavourable resin preference, using a sufficient number of stages could reduce the concentration of Y ions in solution to any level desired.

This analysis simplifies the column technique, but it does provide insights into the process dynamics. Separations are possible despite poor selectivity for the ion being removed.

Referring to FIGS. 1 and 4 and the current invention, the passing of the water through the cation column causes Ca²⁺, Mg²⁺ or Na⁺ ions in the water to displace the H⁺ ions. For ease of reference, Ca²⁺, Mg²⁺ or Na⁺ will hereinafter be referred to as M. The water leaving the cation column contains the H⁺ and no or a limited amount of the cations present in the source water.

Then passing the water to the anion column causes the hydroxide ions to be displaced by one or more of the group of anions (X⁻) including sulphates (SO₄²⁻) and chlorides (Cl⁻), H⁺ ions react with OH⁻ ions to form water (H₂O). The water leaving the anion column contains no or a limited amount of ions and is therefore substantially desalinised.

This can be illustrated by the following chemical reactions:

In the cation column:

M⁺(aq)+HR(s)→MR(s)+H⁺(aq)

In the anion column:

X⁻(aq)+R′OH(s)→R′X(s)+OH⁻(aq)

The H+ and OH− ions released into the water react with each other to form water:

H⁺(aq)+OH⁻(aq)→H₂O

It is expected that a certain amount of stratification will take place in column 1, with the cations for which the cation exchange resin has a higher selectivity like the divalent ions will be in higher concentration at the top of the column and the mono-valent cations will be in higher concentration in the bottom of the column. This will cause the calcium and magnesium ions to settle substantially at the operatively top section of the cation column and the sodium cations to settle substantially at the operatively bottom of this column.

Similar stratification will take place in the column 2, with anions for which the anion resin has a higher selectivity, like the sulphates, will settle in higher concentration at the top of the column and the other anions, like the chlorides, will settle in higher concentration at the bottom of this column. This is illustrated in FIG. 4.

When breakthrough occurs, in other words when the concentration of the cations other than H⁺ and/or anions other than OH⁻ in the outflow rises to unacceptable levels, then the water flow through the columns is stopped in order to regenerate the resins.

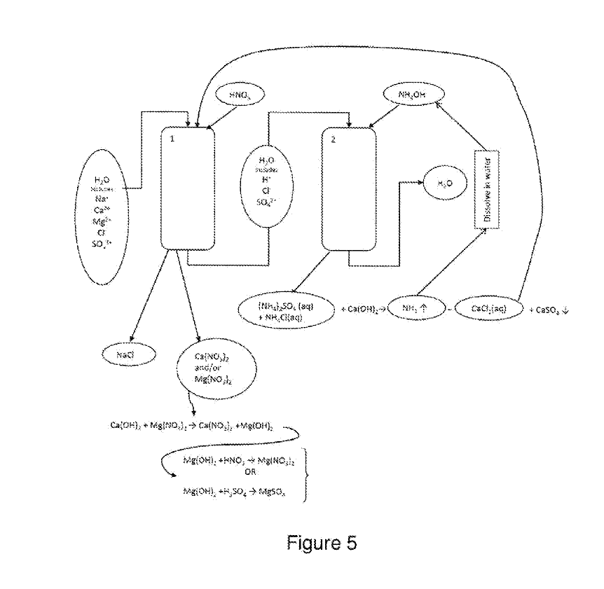

The anion resin is then regenerated with ammonium hydroxide to form a mixture of ammonium chloride and/or ammonium sulphate, as shown in FIG. 5.

The ammonium chloride and ammonium sulphate mixture is then treated with calcium hydroxide that form calcium sulphate that precipitate, ammonia gas that can be stripped from the solution to be re-dissolved and be reused again for the next cycle when the anion resin is regenerated. The third compound that will be formed is calcium chloride.

The anion resin (R′) regeneration can be expressed by the following equations:

3NH₄OH(aq)+R′SO₄(s)+R′Cl(s)→R′OH(s)+(NH₄)₂SO₄(aq)+NH₄Cl(aq)

(NH₄)₂SO₄(aq)+NH₄Cl(aq)+Ca(OH)₂→CaSO₄↓+NH₃↑+CaCl₂(aq)

The cation resin is then regenerated, still as shown in FIG. 5. The Na⁺ concentrated on the bottom of the cation column is removed by pumping the CaCl₂(aq) solution just produced as described above through the cation column to produce a sodium chloride (NaCl) solution.

The regeneration can then follow one of two alternatives, namely:

Alternative 1, as shown in FIG. 5:—

The cation resin is further regenerated with nitric acid (HNO₃) to form a mixture of calcium and magnesium nitrate. (In the reaction below only the reaction related to calcium will be shown.)

CaCl₂(aq)+2NaR(s)→CaR(s)+2NaCl(aq) R Step 1

HNO₃(aq)+CaR(s)→HR(s)+Ca(NO₃)₂(aq) R Step 2

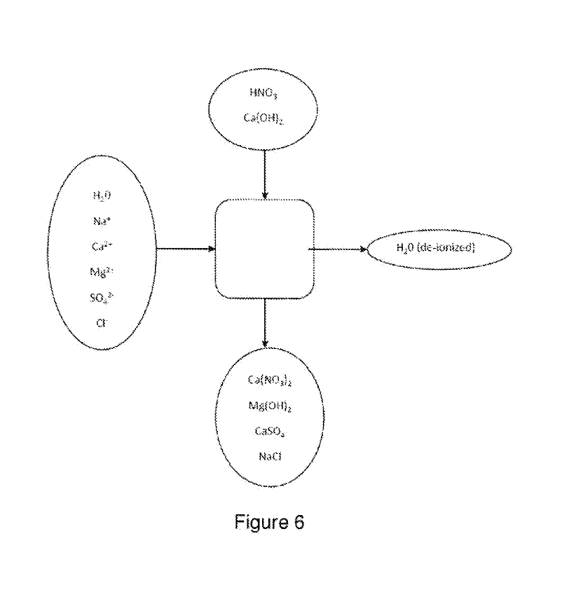

The total flow of liquids for the process including the full regeneration using alternative 1 for the cation resin regeneration is shown in FIG. 6.

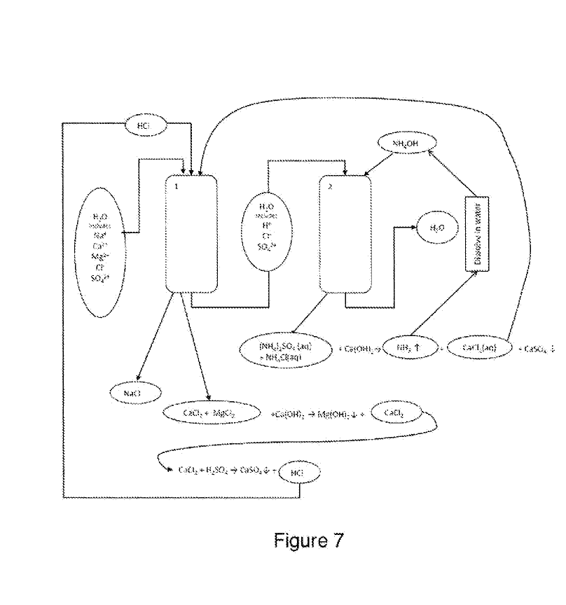

Alternative 2, as shown in FIG. 7:—

The cation resin is then regenerated with hydrochloric acid to form a mixture of calcium and magnesium chloride. (In the reaction below only the reaction related to calcium will be shown.)

CaCl₂(aq)+2NaR(s)→CaR(s)+2NaCl(aq) R Step 1

2HCl(aq)+CaR(s)→HR(s)+CaCl₂(aq) R Step 2

The calcium and magnesium chloride mixture is then treated with calcium hydroxide to precipitate magnesium hydroxide leaving a calcium chloride solution which then treated with sulphuric acid to form calcium sulphate that precipitates and hydrochloric acid that can be reused when the cation resin is to be regenerated again.

CaCl₂+MgCl₂+Ca(OH)₂→Mg(OH)₂↓2CaCl₂

CaCl₂+H₂SO₄→CaSO₄↓+2HCL

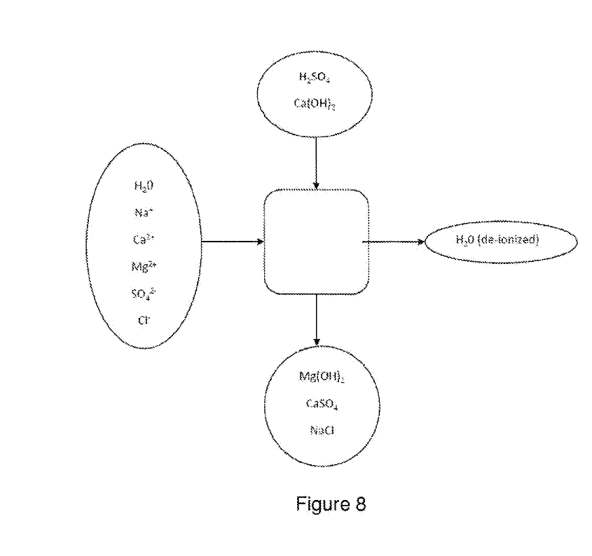

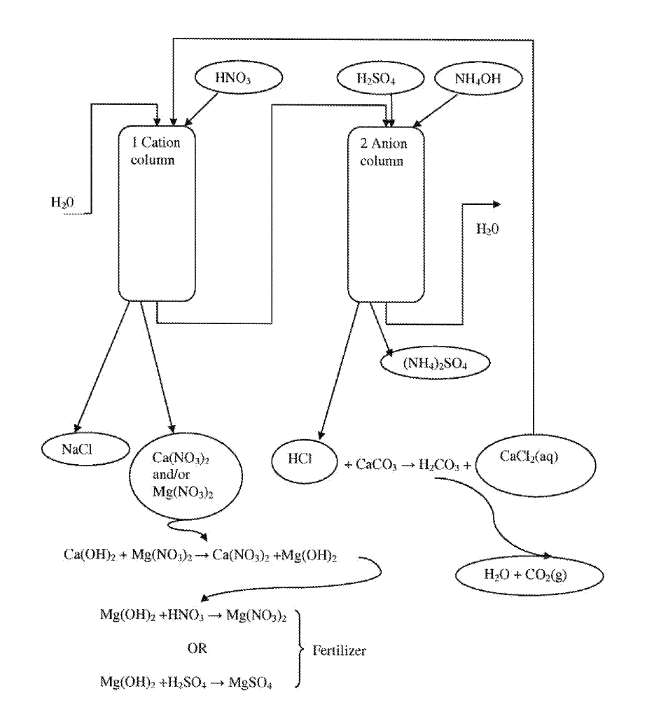

The total flow of liquids for the process including the full regeneration using alternative 2 for the cation resin regeneration is shown in FIG. 8.

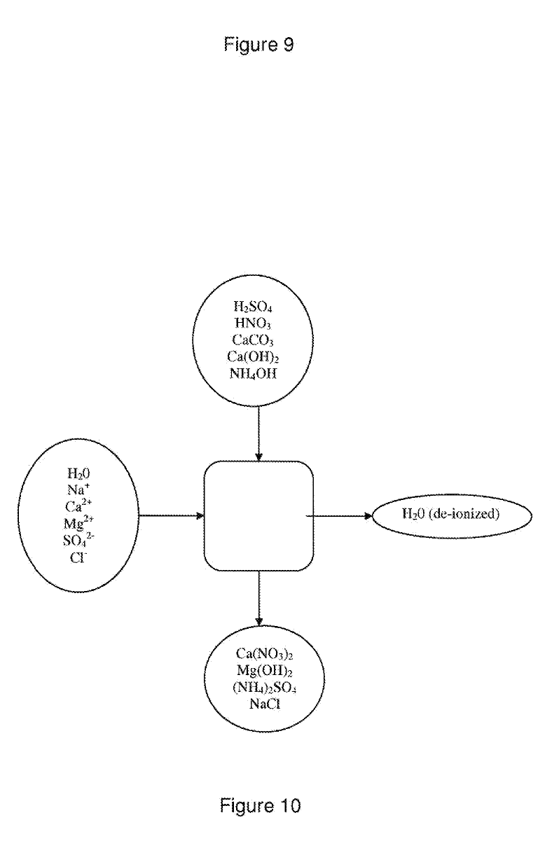

In an alternative to the anion column regeneration described above, and as shown in FIG. 9, it is possible to first displace

the Cl⁻ ions on the anion resin in the anion column by passing a sulphuric acid (H₂SO₄) solution, preferably diluted, through the anion column. This displaces through greater selective absorption chlorine ions adsorbed onto the resin by sulphate ions to produce hydrochloric acid (HCl) from the anion column.

The anion exchange resin is then regenerated by passing an ammonium hydroxide (NH₄OH) solution through the anion column to displace sulphate ions (SO₄²⁻) adsorbed onto the resin with hydroxide ions (OH⁻), this will produce an ammonium sulphate ((NH₄)₂SO₄) solution from the anion column, thereby leaving an hydroxide ion (OH⁻) loaded anion column. Ammonium sulphate ((NH₄)₂SO₄) is useful as a fertilizer. This can be illustrated by the following chemical reactions:

SO₄²⁻(aq)+R′Cl(s)→R′SO⁴(s)+Cl⁻(aq)

and

2NH₄OH(aq)+R′SO₄(s)→R′OH(s)+(NH₄)₂SO₄(aq)

In the above chemical reaction, R′Cl(s) means Cl⁻ absorbed onto the resin the anion exchange column.

The hydrochloric acid produced from the anion column is then neutralized by means of calcium carbonate (CaCO₃) to produce a solution containing carbonic acid (H₂CO₃) and a calcium chloride (CaCl₂) solution.

This can be illustrated by the following chemical reaction:

2HCl+CaCO₃→H₂CO₃+CaCl₂(aq)

The carbonic acid will naturally dissociate to water (H₂O) and carbon dioxide gas (CO₂) whereas the calcium chloride (CaCl₂ (aq)) will remain in solution, and is passed through the cation column to displace mainly sodium (Na⁺) concentrated at the bottom of the cation column, to produce mainly sodium chloride (NaCl) from the cation column.

This can be illustrated by the following chemical reactions:

H₂CO₃→H₂O+CO₂

and

CaCl₂(aq)+2NaR(s)→CaR(s)+2NaCl(aq)

Alternatively, the hydrochloric acid may be neutralized by calcium hydroxide (Ca(OH)₂) in substantially the same way as described above which will yield calcium chloride and water.

This can be illustrated by the following chemical reaction:

2HCl+Ca(OH)₂→2H₂O+CaCl₂(aq)

Still as shown in FIG. 9, the cation exchange resin is regenerated by passing nitric acid (HNO₃) through the cation column to displace at least one of calcium and magnesium ions adsorbed onto the resin by hydrogen ions to produce calcium nitrate (Ca(NO₃)₂) and/or magnesium nitrate (Mg(NO₃)₂) from the first column. This will leave a cation column loaded with hydrogen ions.

This can be illustrated by the following chemical reactions:

HNO₃(aq)+CaR(s)→HR(s)+Ca(NO₃)₂(aq)

HNO₃(aq)+MgR(s)→HR(s)+Mg(NO₃)₂(aq)

The calcium nitrate and magnesium nitrate can be used as a fertilizer.

It is however not preferable to have a calcium nitrate and magnesium nitrate mixture in solution and it is desirable to separate them. In order to do so, calcium hydroxide (Ca(OH)₂) may be added to the solution. The magnesium nitrate will react with the calcium hydroxide to form more calcium nitrate and magnesium hydroxide (Mg(OH)₂), which will precipitate due to its low solubility and can be separated from the solution. This will leave a calcium nitrate solution that can be used as a fertilizer.

This can be illustrated by the following chemical reaction:

Mg(NO₃)₂+Ca(OH)₂→Mg(OH)₂+Ca(NO₃)₂

Still as shown in FIG. 9, neutralizing the magnesium hydroxide (Mg(OH)₂) with nitric acid (HNO₃) will form magnesium nitrate. Alternatively, sulphuric acid (H₂SO₄) may be added to the magnesium hydroxide (Mg(OH)₂) as neutralizer which will yield magnesium sulphate (MgSO₄). Both of these salts are suitable as fertilizers.

This can be illustrated by the following chemical reactions:

Mg(OH)₂+2HNO₃→Mg(NO₃)₂+2H₂O

Mg(OH)₂+H₂SO₄→MgSO₄+2H₂O

FIG. 10 shows the liquid flows for the process as described with reference to FIG. 9.

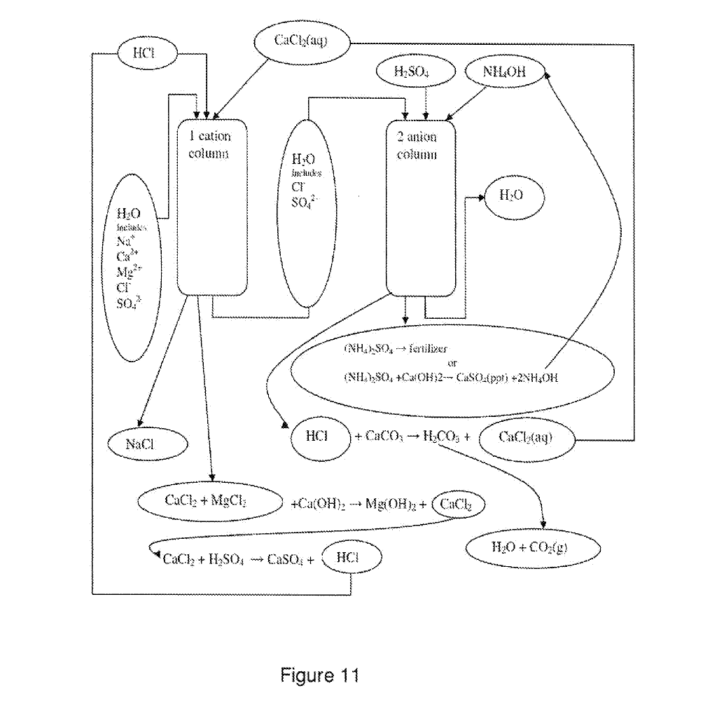

As shown in FIG. 11, it is also possible to regenerate the cation exchange resin by passing hydrochloric acid (HCl) instead of nitric acid (HNO₃) through the cation column. This will displace at least one of calcium and magnesium ions adsorbed onto the resin by hydrogen ions to produce calcium chloride (CaCl₂) and/or magnesium chloride (MgCl₂) from the first column. This will leave a cation column loaded with hydrogen ions.

This can be illustrated by the following chemical reactions:

HCl(aq)+CaR(s)→HR(s)+CaCl₂(aq)

HCl(aq)+MgR(s)→HR(s)+MgCl₂(aq)

The calcium chloride and magnesium chloride thus formed is then treated first with calcium hydroxide (Ca(OH)₂ to precipitate magnesium hydroxide (Mg(OH)₂) from the solution. That leaves calcium chloride (CaCl₂) which is then treated with sulphuric acid (H₂SO₄). This causes the precipitation of calcium sulphate (CaSO₄) and the creation of hydrochloric acid (HCl). The hydrochloric acid (HCl) may then be used again to regenerate the cation column in its next regeneration cycle. This makes use of the bulk of the recyclable products in the circuit.

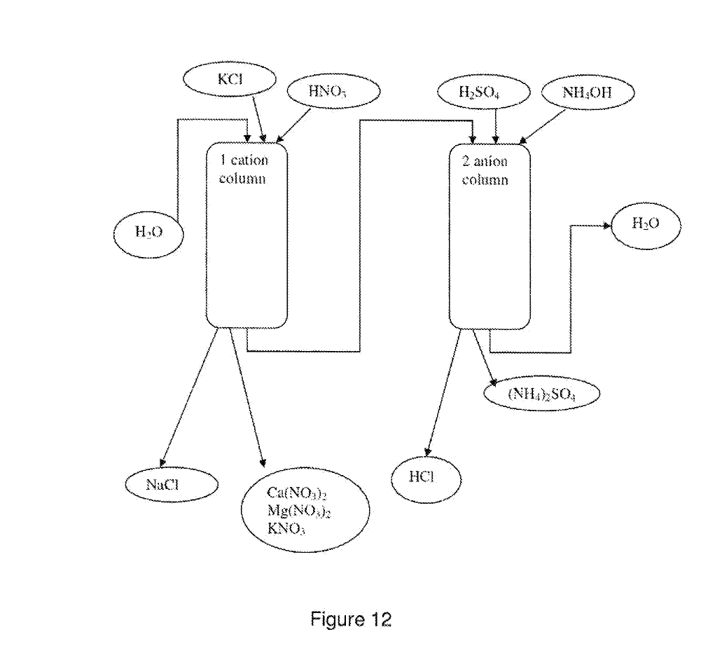

A fourth embodiment of the invention is shown in FIG. 12. In this embodiment the hydrochloric acid (HCl) generated from the anion column is recovered as it is, and not neutralized to yield calcium chloride (CaCl₂) as shown in FIGS. 9 and 11. This embodiment is useful in situations where there is a market for a mixture of nitrate based fertilizer and where there is a ready and close market for hydrochloric acid.

In this fourth embodiment, the sodium ions (Na⁺) adsorbed onto the resin (refer FIG. 4) is replaced with potassium ions (K⁺) by passing potassium chloride (KCl) through the cation column, which produces sodium chloride from the cation column and leaves potassium ions on the resin. Nitric acid (HNO₃) is then passed through the cation column, to displace the potassium ions (K⁺) and the already present calcium ions (Ca²⁺) and magnesium ions (Mg²⁺) with hydrogen ions (H⁺), producing calcium nitrate ((CaNO₃)₂), magnesium nitrate ((MgNO₃)₂), and potassium nitrate (KNO₃), and a cation column loaded with hydrogen ions ready for the next cycle of water treatment.

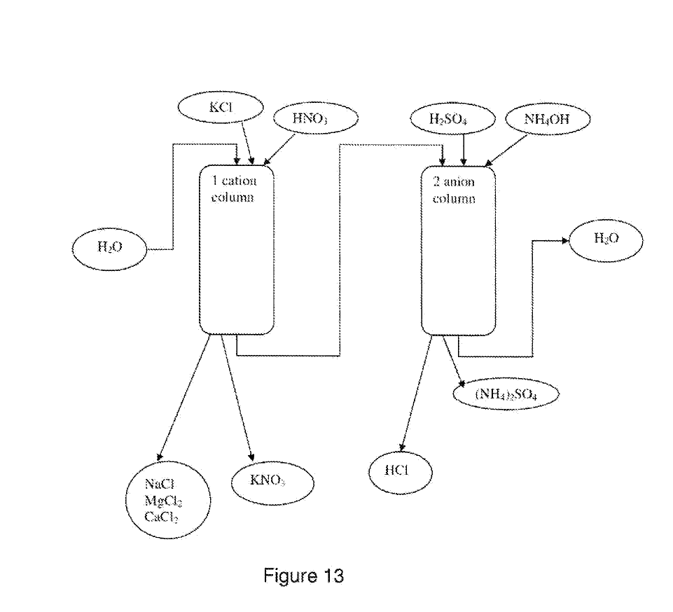

A fifth embodiment of the invention is shown in FIG. 13. This is similar to the fourth embodiment shown in FIG. 12, apart from that potassium chloride (KCl) is used to strip all the ions from the cation column, to yield sodium chloride (NaCl) magnesium chloride (MgCl₂), calcium chloride (CaCl₂), and after regeneration with nitric acid, potassium nitrate (KNO₃).

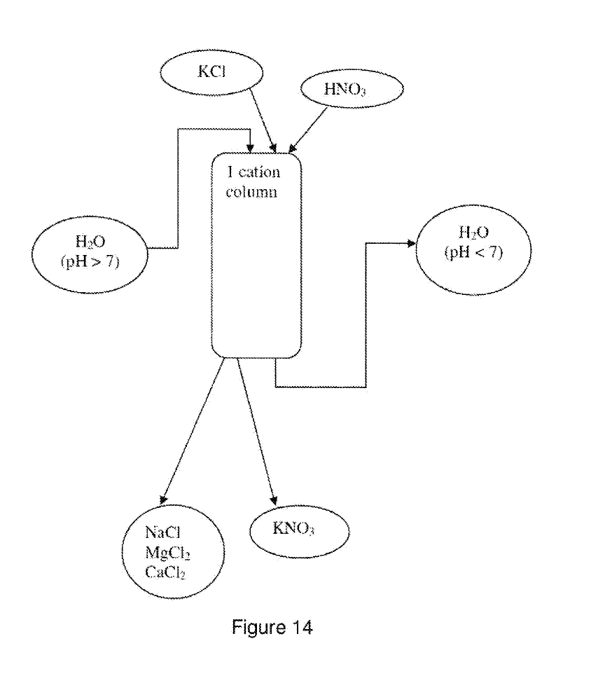

A sixth embodiment is shown in FIG. 14. In this embodiment only the cation column is used. This is done in instances when the bicarbonate concentration in the water is very high and there is a need for the pH to be reduced without increasing the total dissolved solids “TDS” of the water. This is similar to the cation leg of the third and fourth embodiments shown in FIGS. 12 and 13, but only the cation column is used.

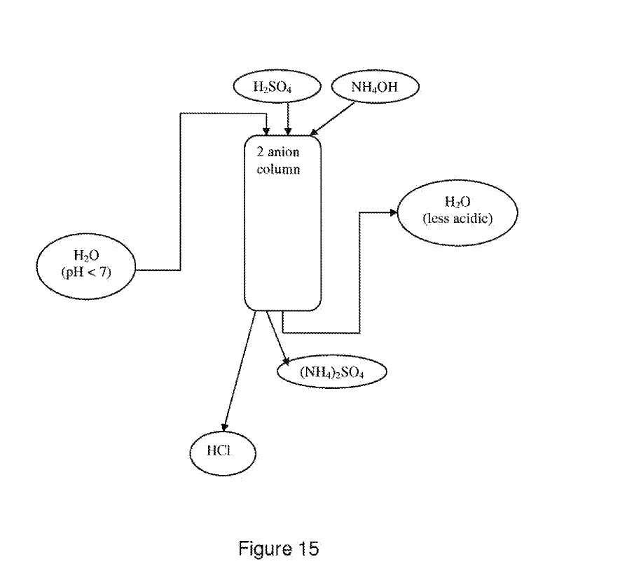

A seventh embodiment of the invention is shown in FIG. 15. This is similar to the fifth embodiment shown in FIG. 13, but in this instance only the anion column is used. This is done in instances when the pH of the water is too low (and thuds almost acidic), and the water needs to be neutralized without increasing the total dissolved solids “TDS” of the water.

By making use of the various embodiments of the invention it is possible to pass source water through the columns in the manners described herein, using sulphuric acid, nitric acid, ammonium hydroxide, calcium carbonate and/or calcium hydroxide to yield de-ionized and substantially desalinized water as well as useful waste products such as calcium nitrate, magnesium hydroxide, ammonium sulphate and sodium chloride in an economically viable way.

Very often, during the abovementioned steps, unwanted elements may be present in the source water like heavy metals for example lead (Pb) and cadmium (Cd). These unwanted elements may be removed prior to the source water entering the cation column by passing the water first through a column which includes a resin with selectively for these elements.

In addition, during the abovementioned steps, other compounds like ammonium (NH₄⁺), nitrate (NO₃⁻) and phosphate (PO₄³⁻) may also be present in the source water. The ammonium will be absorbed on the cation exchange resin and the nitrate and phosphate will be absorbed on the anion exchange resin.

When the cation exchange resin is regenerated as described above the ammonium will end up with the calcium nitrate (Ca(NO₃)₂) solution as ammonium nitrate (NH₄NO₃), giving a mixture of calcium and ammonium nitrate.

When the anion exchange resin is regenerated as described above the nitrate will end up in the ammonium sulphate solution as ammonium nitrate, giving a mixture of ammonium sulphate ((NH₄)₂SO₄) and ammonium nitrate (NH₄NO₃).

1. A method of water desalination which includes the steps of:
a. passing water through a cation column which includes a resin loaded with hydrogen ions to absorb on the resin one or more of the group of cations including calcium, magnesium and sodium ions from the water and to displace the hydrogen ions;
b. passing the water from step a) through an anion column which includes a resin loaded with hydroxide ions to absorb on the resin one or more of the group of anions including sulphate and chloride ions from the water and to displace the hydroxide ions to yield desalinated water;
c. regenerating the anion column by passing a solution containing at least one species which includes hydroxide ions bound with a carrier ion, to displace from the resin the sulphate and chloride ions to leave a hydroxide loaded resin and producing mainly a solution containing a mixture of sulphate and chloride ions and the carrier ion; and
d. regenerating the cation column by
i. passing through the cation column a chloride containing feed solution which includes chloride ions bound with a counter-ion which has greater selective adsorption on the resin than the sodium ions, to displace from the resin almost all of the sodium ions and at least some of the other cations absorbed in step a) to leave a resin loaded with the counter-ions and some of the other cations absorbed in step a), and producing a chloride product solution containing most of the sodium and at least some of the other cations absorbed in step a) from the cation column; and
ii. passing through the cation column a nitric acid solution or a hydrochloric acid solution through the cation column to displace the cations left on the resin after step di) by hydrogen ions and to produce nitrates or chlorides of the cations left on the resin after step di) from the cation column, thereby leaving a hydrogen ion loaded cation column.

2. A method as claimed in claim 1 in which the hydroxide species of step c) comprises ammonium hydroxide and step c) comprises passing an ammonium hydroxide solution through the anion column to displace the chloride and sulphate ions adsorbed on the resin by hydroxide ions and to produce mainly a mixture of ammonium chloride and ammonium sulphate from the anion column.

3. A method as claimed in claim 2 which includes treating the ammonium chloride and ammonium sulphate of step c) with calcium hydroxide to produce a solution containing calcium sulphate, ammonia gas and calcium chloride, of which the calcium sulphate precipitates from the solution, and the ammonia gas may be stripped from the solution and redissolved in water to form ammonium hydroxide for use in step c).

4. A method as claimed in claim 3 in which the chloride containing feed solution of step di) comprises calcium chloride and the method includes feeding the calcium chloride solution to step di), to displace most of the sodium and some of the other cations adsorbed on the resin with calcium and to produce a chloride product solution containing most of the sodium from the cation column, and the nitrate mixture or chloride mixture from step dii) then comprise calcium nitrate and calcium chloride respectively.

5. A method as claimed in claim 1 which, should the nitrate mixture from the cation column from step dii) contain any magnesium, includes the addition of calcium hydroxide to the mixture, thereby allowing the magnesium nitrate to react with the calcium hydroxide to form calcium nitrate in solution and magnesium hydroxide precipitate.

6. A method as claimed in claim 1 which includes the step of neutralizing the magnesium hydroxide with nitric acid to form magnesium nitrate and water; alternatively neutralizing the magnesium hydroxide with sulphuric acid to form magnesium sulphate and water.

7. A method as claimed in claim 4 which, should the chloride mixture from the cation column from step dii) contain any magnesium, includes the addition of calcium hydroxide to the mixture from the cation column from step dii), thereby allowing the magnesium chloride to react with the calcium hydroxide to form calcium chloride in the solution and magnesium hydroxide precipitate.

8. A method as claimed in claim 7 which includes the step of contacting the calcium chloride with sulphuric acid to form calcium sulphate precipitate and hydrochloric acid, of which the latter is preferably passed through the cation column in step dii) again.

9. A method as claimed in any one of claims 1 to 3 in which the chloride containing feed solution of step di) comprises potassium chloride and step di) comprises passing potassium chloride solution through the cation column to displace mainly sodium adsorbed on the resin with potassium, producing mainly sodium chloride from the cation column, and step dii) comprises passing nitric acid through the cation column to displace calcium, magnesium and potassium adsorbed on the resin by hydrogen ions and to produce calcium nitrate, magnesium nitrate and potassium nitrate from the cation column, thereby leaving a hydrogen ion loaded cation column.

10. A method as claimed in claim 9 which includes passing the potassium chloride solution through the cation column in step di) in a volume sufficient to displace all the cations on the cation column to produce sodium chloride, magnesium chloride and calcium chloride; and passing nitric acid through the cation column to produce potassium nitrate from the cation column, thereby leaving a hydrogen ion loaded cation column.

11. A method as claimed in claim 1 in which step c) comprises passing a sulphuric acid solution through the anion column to displace the chloride ions adsorbed on the resin by sulphate ions and to produce mainly hydrochloric acid from the anion column, and thereafter passing an ammonium hydroxide solution through the anion column to displace sulphate ions adsorbed on the resin with hydroxide ions and producing an ammonium sulphate solution from the anion column, thereby leaving a hydroxide ion loaded anion column.

12. A method as claimed in claim 11 which includes the step of neutralizing the hydrochloric acid by means of calcium carbonate to produce a solution containing carbonic acid and calcium chloride, of which the carbonic acid dissociates mostly into water and carbon dioxide in solution, alternatively the step of neutralizing the hydrochloric acid by means of calcium hydroxide instead of, or in addition to, calcium carbonate.

13. A method as claimed in claim 12 in which the calcium chloride is used in step di) as the chloride feed solution.

14. A method as claimed in claim 11 or 13 in which the ammonium sulphate solution is contacted with calcium hydroxide to form calcium sulphate that precipitates from the solution and ammonium hydroxide and optionally passing the ammonium hydroxide to step c) to displace the sulphate ions on the anion column.

15. A method of treatment of water which includes the steps of:
a. passing water with a pH value higher than 7, as a first step, through a cation column which includes a resin loaded with hydrogen ions to absorb in the resin one or more of the group of cations including calcium, magnesium and sodium from the water and to displace the hydrogen ions to yield water with a pH value lower than 7;
b. passing potassium chloride solution in a sufficient volume through the cation column to displace all the cations on the cation column adsorbed on the resin with potassium, to produce sodium chloride, magnesium chloride and calcium chloride from the cation column; and
c. passing nitric acid through the cation column to displace potassium adsorbed on the resin by hydrogen ions and to produce potassium nitrate from the cation column, thereby leaving a hydrogen ion loaded cation column.

16. A method of treatment of water to reduce the pH value of the water, which includes the steps of:
a. passing water, preferably with a pH value above 7, through a cation column which includes a resin loaded with hydrogen ions to absorb in the resin one or more of the group of cations including calcium, magnesium and sodium from the water and to displace the hydrogen ions, yielding water with a pH value lower than 7;
b. passing a potassium chloride solution through the cation column to displace mainly the sodium adsorbed on the resin by potassium ions and to produce mainly sodium chloride, thereby leaving a calcium, magnesium and potassium ion loaded cation column; and
c. passing a nitric acid solution through the cation column to displace calcium, magnesium and potassium with hydrogen and produce calcium, magnesium and potassium nitrate, thereby leaving a hydrogen ion loaded cation column.

17. A method as claimed in claim 15 which includes the step of contacting water with a pH value lower than 7 with calcium carbonate or ammonia and to yield water with an increased calcium or ammonium concentration for partial or full neutralisation of the water.

18. A method of treatment of water to increase the pH value of the water, which includes the steps of:
a. passing water, preferably with a pH value below 7, through an anion column which includes a resin loaded with hydroxide ions to absorb in the resin one or more of the group of anions including sulphate and chloride ions from the water and to displace the hydroxide ions;
b. passing a sulphuric acid solution through the anion column to displace the chloride ions adsorbed on the resin by sulphate ions and to produce mainly hydrochloric acid from the anion column; and
c. passing an ammonium hydroxide solution through the anion column to displace sulphate ions adsorbed on the resin with hydroxide ions and producing an ammonium sulphate solution from the anion column, thereby leaving a hydroxide ion loaded anion column, to yield water with a higher pH value compared to what it entered the process without increasing the total dissolved solids in the water.

19. A method as claimed in claim 17 in which the ammonium sulphate solution is contacted with calcium hydroxide to form calcium sulphate that precipitates from the solution and ammonium hydroxide, and optionally passing the ammonium hydroxide to step c) of claim 18 to displace the sulphate ions on the anion column.

20. A method as claimed in anyone of claims 1 to 19 which includes the steps of removing any one or more of the group of compounds including ammonium (NH₄⁺), nitrate (NO₃⁻) and phosphate (PO₄³⁻) from source water by absorbing ammonium on the cation exchange resin and absorbing nitrate and phosphate on the anion exchange resin.

21. A method as claimed in anyone of claims 2 to 20 which includes the step of treating the ammonium sulphate solution produced from the anion column with calcium hydroxide to produce calcium sulphate precipitate and an ammonium hydroxide solution, and optionally feeding the ammonium hydroxide to the anion column to displace sulphate ions adsorbed on the resin with hydroxide ions and producing an ammonium sulphate solution from the anion column.

22. A system for the treatment of water which includes a cation exchange column including a cation exchange resin and an anion exchange column including a resin with an anion exchange resin, each column including an inlet and outlet and being in fluid communication with each other to enable the system to perform the steps of the method as claimed in any one of claims 1 to 21.

23. A system as claimed in claim 22 which includes an additional column containing a cation exchange resin with a selectivity for heavy metals to remove unwanted elements like heavy metals, including without limitation lead (Pb) and cadmium (Cd) to be removed from the source water prior to it entering the cation column.

24. A method as claimed in any one of claims 1 to 21 which includes the step of passing source water through an additional column as claimed in claim 23 prior to the source water entering the cation column.
